(19) United States
(12) Patent Application Publication
(10) Pub. No.: US 2020/0034284 A1
(43) Pub. Date: Jan. 30, 2020

(54) AUTOMATIC BUG REPRODUCTION USING REPLICATION AND CPU LOCKSTEP

(71) Applicant: EMC IP Holding Company LLC, Hopkinton, MA (US)

(72) Inventors: Alex Solan, Hertzella (IL); Udi Shemer, Kfar Saba (IL)

(21) Appl. No.: 16/044,829

(22) Filed: Jul. 25, 2018

(51) Int. Cl. G06F 11/36; G06F 9/455

(52) U.S. Cl. CPC G06F 11/3696; G06F 11/362; G06F 2009/45562; G06F 9/45558; G06F 2009/4557; G06F 9/45541

(57) ABSTRACT

Embodiments are directed to a bug reproduction system and method to reproduce non-probabilistic bug conditions in programs, such as those that involve multi-threaded race conditions and/or containerized systems. To consistently reproduce a phenomenon that usually happens with low probability, embodiments provide an effective approach to consistently reproducing bugs by combining multi-point-in-time replication (like RecoverPoint), CPU lockstep and the same constructs used in implementing VMware VMotion functionality. The result is a system that once there is an initial reconstruction, will be able to consistently reproduce the same issue one hundred percent of the time.

### TECHNICAL FIELD

This invention relates generally to software development systems, and more specifically to reproducing non-regular bugs using CPU lockstep and virtual machine live migration methods.

### BACKGROUND OF THE INVENTION

Software development efforts require effective debugging tools. A key task in fixing bugs is finding and reproducing so that problematic conditions can be accurately identified and corrected. Some bugs, such as those that occur regularly, can be simply localized and reproduced by re-running the logical scenario that gave rise to the problem. The developer can add logs to the re-execution and use other debugging tools until the problematic scenario is clear. The more problematic bugs are probabilistic bugs, which are those that happen only once in a while or on an irregular basis. The first time that such a bug happens, the developer lacks the evidence to analyze it and must wait until it happens again. This makes the reproduction of such bugs costly and ultimately may impair the quality of product passed to customers. The main issue is consistently reproducing a phenomenon that usually happens with low probability. Even after creating a fix, one cannot be absolutely sure that the reproduction is successful or that the bug is fixed.

In a multi-threaded computing environment, probabilistic bugs are usually caused by a special and unexpected case of interactions between threads. These kind of bugs can be exceedingly difficult to analyze, and as the thread count in each process grows, the analysis becomes even more complicated. Bug reconstruction complexity also increases with the number of processes. Having many processes or services interacting with each other increases the occurrence of such bugs. Even if a bug occurs multiple times, it can manifest slightly differently in each occurrence, which makes the analysis more difficult. Furthermore, the very act of debugging software code may alter the fault condition. For example, in certain race-conditions, the debugger can change the system (e.g., setting CPU registers) in a way that causes the fault condition to change or even disappear. Bug reconstruction complexity also increases in a containerized system with cross container interaction. The advent of containerization has given rise to an increase in non-predicted interaction between containers, which further complicates the reproduction of bugs in these environments.

What is needed, therefore, is a testing method and system that accurately reconstructs a software bug condition and consistently reproduces the condition one hundred percent of the time.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. VMotion and vLockstep are trademarks of VMware Corporation. RecoverPoint is a trademark of DellEMC Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1A illustrates a software development system that implements one or more embodiments of a test program including a bug reproduction process under some embodiments.

FIG. 1B illustrates a computer network system that implements one or more embodiments of a test program including a bug reproduction process under some embodiments.

FIG. 2 illustrates a composition of the bug reproduction process under some embodiments.

FIG. 3 is a flowchart that illustrates a process of performing bug reproduction under some embodiments.

FIG. 4 illustrates an example event and state time line as captured by the bug reproduction process under some embodiments.

FIG. 5 illustrates the time line of FIG. 4 with an example bug condition occurring between two particular captured states.

FIG. 6 is a flowchart that illustrates a method of replaying a bug condition under some embodiments.

FIG. 7 is a system block diagram of a computer system used to execute one or more software components of bug reproduction process for a software development and testing system, under some embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the described embodiments may take, may be referred to as techniques. In general, the order of the steps of disclosed processes may be altered within the scope of the invention.

Some embodiments of the invention involve software development of software products and programs that provide or enable the use of application software in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

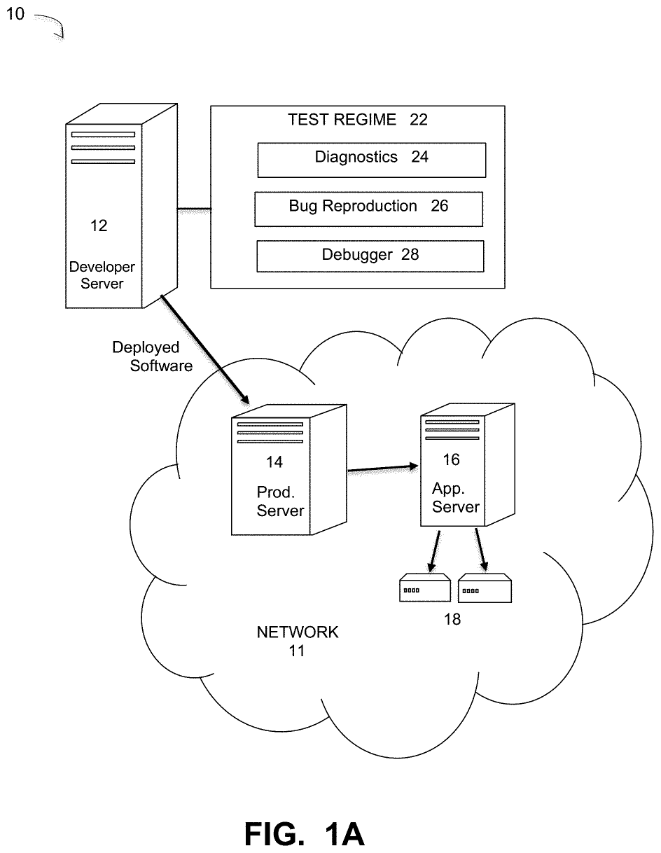

FIG. 1A illustrates a software development system that implements one or more embodiments of a test program including a bug reproduction process under some embodiments. In a typical software development environment, such as that exemplified by system 10, software is developed in a server or servers operated by a software developer. The software developer writes the program code and tests it certain known or proprietary test routines under a testing regime 22. The test routines or diagnostics programs 24 test certain operational aspects of the code to find faults and bugs. A debugger module or program 28 is used to perform certain debugging practices with regard to the tested program code, such as parsing the code to find programming errors, executing routines and subroutines to find fault conditions, comparing execution results to accepted output measures, and other similar debugging procedures. Once a program has exhibited a sufficient degree of faultless performance, such as established by a quality assurance (QA) team, it is ready for distribution to a production environment. Such a production environment may be a customer network 11 that includes a production server 14 that deploys copies of the software product to other computer resources. In the case where the program is an application, deployment of the production version may be to servers, such as application server 16 that receive requests or calls from clients 18 to perform certain tasks. The program development environment of FIG. 1A is intended to an example only, and any type of deployed software program and target computer system may be used according to the embodiments described herein. For example, certain tasks of the test regime 22 may be offloaded and performed by different servers, such as the debugger 28.

In general, the nature of the bugs or problems discovered by the test regime 22 and debugger 28 depends on a great many factors, such as complexity of the code, deployment environment, production constraints, and so on. Accurately reproducing any detected bugs is a critical process in successfully debugging the program code. As stated above, in modern large-scale networks, bug reproduction, especially in programs that involve multi-threaded race conditions and/or containerized systems is generally quite difficult, as it is great challenge to consistently reproduce a program fault that usually happens with low probability. Embodiments of the test regime 22 include a bug reproduction process 26 that consistently reproduces bugs by combining multi-point-in-time replication (like RecoverPoint), CPU lockstep and the certain constructs used in implementing live migration of virtual machines, such as VMware VMotion functionality. Once the bug or fault condition is adequately or consistently reproduced, the results can be sent to the debugger 28 for detailed analysis and correction. Although the test regime 22 is illustrated as a unitary process executed by server 12, embodiments are not so limited. For example, certain tasks of the test regime 22, such as debugger 28, may be offloaded and performed by different servers. In addition, though FIG. 1A illustrates the bug reproduction process 26 as being executed by the developer server, this process or portions of this process may be executed in the production environment, such as by production server 14, and the results sent to the backend server 12 for analysis using debugger 28 or other analysis software.

In an embodiment, the deployed software comprises application or other software programs executed by one or more servers and/or clients in a large-scale virtual machine system, though embodiments are not so limited. FIG. 1B illustrates a computer network system that implements one or more embodiments of a test program including a bug reproduction process under some embodiments. For the embodiment of FIG. 1B, network server and client computers are coupled directly or indirectly to one another through network 110, which may be a cloud network, LAN, WAN or other appropriate network. Network 110 provides connectivity to the various systems, components, and resources of system 100, and may be implemented using protocols such as Transmission Control Protocol (TCP) and/or Internet Protocol (IP), well known in the relevant arts. In a distributed network environment, network 110 may represent a cloud-based network environment in which applications, servers and data are maintained and provided through a centralized cloud computing platform. In an embodiment, system 100 may represent a multi-tenant network in which a server computer runs a single instance of a program serving multiple clients (tenants) in which the program is designed to virtually partition its data so that each client works with its own customized virtual application.

Virtualization technology has allowed computer resources to be expanded and shared through the deployment of multiple instances of operating systems and applications run virtual machines (VMs). A virtual machine network is managed by a hyperwisor or virtual machine monitor (VMM) program that creates and runs the virtual machines. The server on which a hypervisor runs one or more virtual machines is the host machine, and each virtual machine is a guest machine. The hypervisor presents the guest operating systems with a virtual operating platform and manages the execution of the guest operating systems. Multiple instances of a variety of operating systems y share the virtualized hardware resources. For example, different OS instances (e.g., Linux and Windows) can all run on a single physical computer.

In an embodiment, system 100 illustrates a virtualized network in which a hypervisor program 112 supports a number (n) VMs 104. A network server supporting the VMs (e.g., network server 102) represents a host machine and target VMs (e.g., 104) represent the guest machines. Target VMs may also be organized into one or more virtual data centers 106 representing a physical or virtual network of many virtual machines (VMs), such as on the order of thousands of VMs each. These data centers may be supported by their own servers and hypervisors 122.

The data sourced in system 100 by or for use by the target VMs may be any appropriate data, such as database data that is part of a database management system. In this case, the data may reside on one or more hard drives (118 and/or 114) and may be stored in the database in a variety of formats (e.g., XML or RDMS). For example, computer 108 may represent a database server that instantiates a program that interacts with the database.

The data may be stored in any number of persistent storage locations and devices, such as local client storage, server storage (e.g., 118), or network storage (e.g., 114), which may at least be partially implemented through storage device arrays, such as RAID components. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity drive (optical or magnetic) arrays. In an embodiment, the target storage devices, such as disk array 114 may represent any practical storage device or set of devices, such as fiber-channel (FC) storage area network devices, and OST (OpenStorage) devices. In a preferred embodiment, the data source storage is provided through VM or physical storage devices, and the target storage devices represent disk-based targets implemented through virtual machine technology.

An application 117 or any other relevant software program executed in system 100 may be developed and debugged using the test regime 22 of system 10. As such, it is subject to the bug reproduction process 26 as they it is executed on a target VM (e.g., VM1) in the system in the event that a problem or bug condition is manifested. In a test scenario, operation of the target VM is monitored by the test regime 22 of the development server and any detected bugs are reproduced by the bug reproduction process 26.

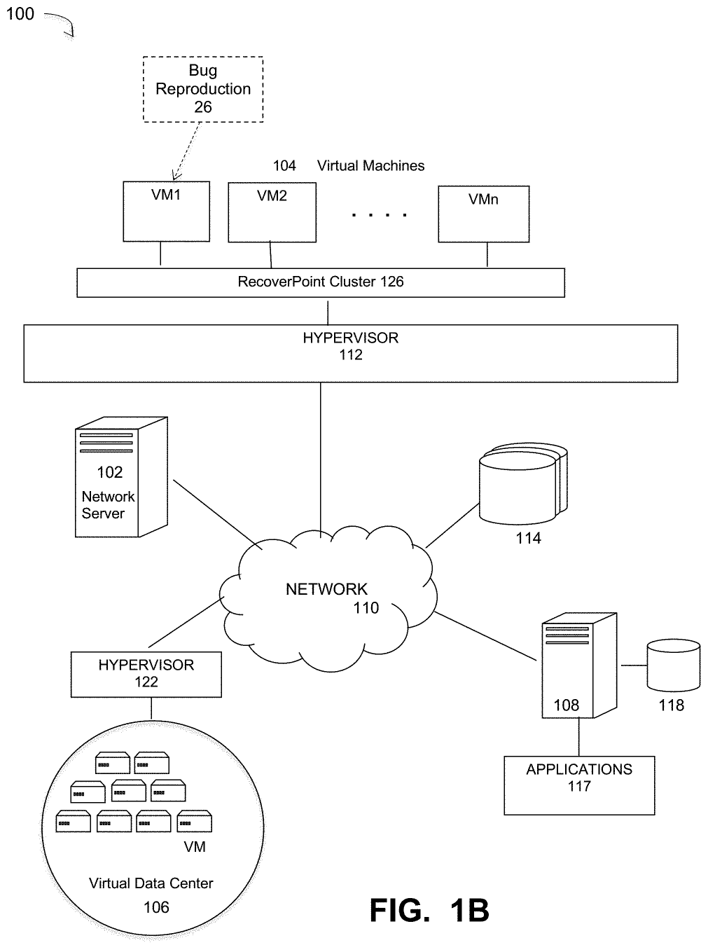

In an embodiment, the bug reproduction process 26 uses three different technologies in combination. FIG. 2 illustrates a composition of the bug reproduction process 26 under some embodiments. As shown in FIG. 2, a first technology is central processing unit (CPU) Lockstep technology 204, which is a widely used mechanism originally built in order to run multiple CPUs in parallel to detect computation discrepancies. CPUs operating in lockstep share a clock and synchronize inputs and are therefore expected to yield the same outputs. A typical topology in critical systems is to run three CPUs in lockstep, compare outputs, and use a majority vote, realigning the processes or threads if a discrepancy is detected. This allows for hardware failures to be immediately compensated for. CPU lockstep technology can be found in a wide range of applications from communication switches and routers, to automobiles, airplanes and space vehicles. Another popular Lockstep topology is dual redundancy (sometimes referred to as master/slave) where the master provides the source clock and all inputs to the slave. The slave therefore runs exactly the same as the master and can be used as redundancy/backup if the master has some hardware failure. Note that the slave is at the same or similar state as the master so it can step in almost seamlessly. The slave usually lags behind the master only a few machine commands if at all. The implementation of lockstep technology is generally CPU architecture dependent, however there are certain common design points. The first is a set of commands with no external (to the CPU) event can be run as an atomic command set. Two CPUs starting at the same deterministic state are guaranteed to reach the exact same state at the end of the atomic set as clock is synchronized and it is guaranteed that there are no asynchronous interruptions. The second is that as a direct result of the previous item, CPUs are guaranteed to move deterministically between a set of consistent states. The states define the CPU state and the synchronized timed external interrupt/events are the trigger to move between states. The third is that inputs, interrupts, and events are synchronized so that they are handled by the CPUs at the exact same clock time and state. This means that the lockstep systems are deterministic and will be calculating the exact same outputs and states.

In a VM environment, such as FIG. 1B, VMware has a virtual machine mode called Fault Tolerance where two VMs are run in lockstep and any failure in the master VM causes the slave VM to take over almost instantaneously. The hypervisor transmits the master synchronization information to the slave using network communication and as a result the slave lags behind the master with time according to the network delay (in addition to the lockstep CPU lag stated before). VMware Fault Tolerance provides continuous availability for VMs by creating and maintaining a secondary VM that is identical to, and continuously available to replace, the primary VM in the event of a failover situation. VMware vLockstep captures inputs and events that occur on the primary VM and sends them to the secondary VM, which is running on another host. Using this information, the secondary VM's execution is identical to that of the primary VM (i.e., in virtual lockstep with the primary VM) so that it can take over execution at any point without interruption. The primary and secondary VMs continuously exchange heartbeats. This exchange allows the virtual machine pair to monitor the status of one another to ensure that fault tolerance is continually maintained.

The second technology 205 of the bug reproduction process 26 is live migration of VMs from one physical server to another physical server, such as provided by the VMware VMotion product and VM State. In VMware VMotion, a VM is moved between two hypervisors with little disruption. This is done by pausing the VM, capturing the full VM state including memory on the source hypervisor, transferring this information to the target hypervisor and continue running the VM again. The transfer is typically completed on the order of a few milliseconds, though in reality it often is done through multiple cycles to reduce the final stopping time. The VM live migration process 205 captures certain state information just prior to the VM transfer. These include: (1) all virtual CPU registers, buffers and state; (2) the contents on all the VM memory; (3) BIOS (basic input/output system) values; and (4) All virtual hardware information and states. The set of the these capture values at a specific point in time is called the “VM State” of the system at that point in time.

Although embodiments of the VM live migration component 205 are described with reference to the VMware VMotion program, embodiments are not so limited and any other similar live migration program may be used. With respect to VMotion, live migration of a virtual machine from one physical server to another is enabled by three underlying technologies. First, the entire state of a virtual machine is encapsulated by a set of files stored on shared storage such as Fibre Channel or iSCSI Storage Area Network (SAN) or Network Attached Storage (NAS). A clustered Virtual Machine File System (VMFS) allows multiple installations of the hypervisor server to access the same virtual machine files concurrently. Second, the active memory and precise execution state of the virtual machine is rapidly transferred over a high speed network, allowing the virtual machine to instantaneously switch from running on the source server to the destination server. VMotion keeps the transfer period imperceptible to users by keeping track of on-going memory transactions in a bitmap. Once the entire memory and system state has been copied over to the target server, VMotion suspends the source virtual machine, copies the bitmap to the target server, and resumes the virtual machine on the target server. The networks being used by the virtual machine are also virtualized by the underlying hypervisor server to preserve network identity and network connections after migration. VMotion manages the virtual MAC (media access controller) address as part of the process.

As shown in FIG. 2, the third technology 206 of bug reproduction process 26 is application consistent VM snapshots. In an embodiment, application consistent snapshots are created by quiescing the VM before taking the snapshot backup. This pauses all input/output (I/O) activity and ensures that the VM is in a completely consistent state. In VMware systems the quiesce is done by the VMtools program, which also performs flush operations on the guest file system prior to pausing the I/Os. Other similar programs or processes to perform the quiesce may also be used.

In an embodiment VMware RecoverPoint is used to perform any point-in-time (PiT) replication that is used together with the quiescing function to create multiple application consistent point in time snapshots. In general, RecoverPoint for virtual machines uses a journal-based implementation to hold the PiT information of all changes made to the protected data. It provides the shortest recovery time to the latest PiT via journal technology enables recovery to just seconds or fractions of a second before data corruption occurred. RecoverPoint for VMs is a fully virtualized hypervisor-based replication and automated disaster recovery solution. As shown in FIG. 1A, VMs 104 are jointed to form a RecoverPoint duster 126 as appliances that are installed on hypervisor server. Depending on system configuration, flexible deployment configurations and hypervisor splitters may reside on all servers with protected workloads, allowing replication and recovery at the virtual disk (VMDK and RDM) granularity level. The I/O splitter resides within the hypervisor so that RecoverPoint for VMs can replicate VMs to and from any storage array supported by the system, such as SAN, NAS, DAS, and vSAN. Although embodiments are described with respect to RecoverPoint for PiT snapshot implementation, any other similar program or product may be used.

### Bug Reproduction

Embodiments include a record-rewind-replay approach at a VM level in the bug reproduction process 26. The process creates static snapshots at various points in time, and also a log describing CPU events, allowing a user or analyst to exactly replay CPU execution scenarios. This allows the use of debuggers or other inspection tools to better analyze bugs or fault conditions in the executing code. The use of CPU lockstep together with the RecoverPoint replication software allows the bug reproduction process to capture I/O interrupts and events and maintain CPU execution cycles that are in sync with the data stored on the disk storage media. The use of RecoverPoint replication ensures that all the data is correct at any point-in-time, and CPU lockstep synchronizes the CPU cycles and events with the data and disk storage state. This allows the bug reproduction process to capture the system state any point-in-time with respect to all pertinent aspects: CPU, I/O, data, storage state, and so on. Any event, fault or bug scenario can be repeated as many times as desired. This allows playback of CPU execution sequences at a granularity one instruction at a time and such repeated sequences happen in the exact same sequence as originally executed and in sync with same clock as the CPU.

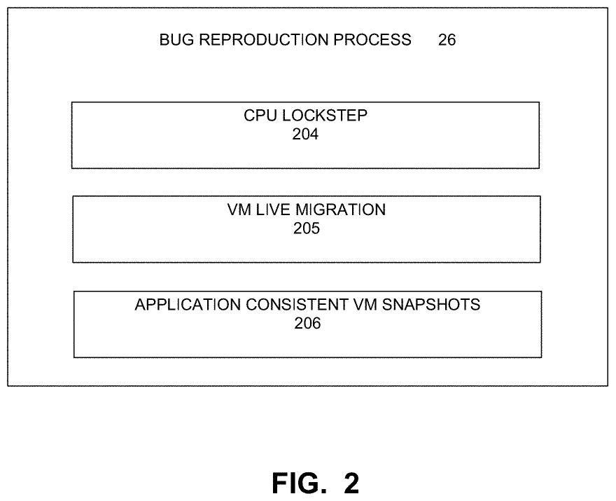

FIG. 3 is a flowchart that illustrates a process of performing bug reproduction under some embodiments. The process 300 starts by capturing the complete system state 302. In an embodiment, the system state comprises the following elements: (1) all or substantially all (e.g., more than 50%) of the virtual CPU registers, buffers and state, (2) the contents of all the VM memory, (3) BIOS values, and (4) all virtual hardware information and states. To these state elements is added (5) the contents of the VM storage or VM disks (VMDKs). Other state items may also be captures, such as some additional data that also may be virtual environment dependent. Such information generally depends on specific system configuration and uses. In general, any desired state information can be captured and can be restored again to work with the bug reproduction process 300. After the state capture step 302 is complete, the process has a complete state of the system with respect to everything that is going on in the VM or VMs down to the last register value that is recorded.

Changes in the state are then captured, step 304. State changes are capture so that the process can replay a given scenario (e.g., bug condition, fault, error, etc.), meaning that the replay will go over the exact states that the original scenario went through. The state change capture step comprises certain sub-steps. Once in a given period, the process will capture the VM state by first quiescing the VM. It then writes the state of memory, storage, CPU, and any other relevant component to disk or other storage. Such storage is usually not the VM disk itself, but rather a datastore or other storage device. A RecoverPoint (or similar) snapshot backup of the VM is then taken.

In between states, the process uses vLockstep (or similar) technology to capture all CPU external events and/or interrupts, step 306. These events are then stored in an event log, step 308. The event log can be embodied as a simple file with time-stamped entries, or it can be a time-ordered data structure, or any other similar data storage construct. As is generally known, an interrupt is a signal to the CPU generated by a hardware component or software process indicating an event that needs immediate attention, and that causes interruption of the code currently being executed by the CPU.

The CPU external events include all network traffic data that is received or processed or otherwise impacts the VM, interrupts (e.g., I/O interrupts, fault conditions, etc.), and any other relevant processing markers, along with the precise timing information of these events. The timing information is precise to the CPU instruction level timing to maintain sync with the CPU clock. Keeping all this data persistently allows the system to accurately reproduce the bug that caused the problem or anomaly. It should be noted that the states captured in steps 302 and 304 of process 300 comprise the full machine state, and not only disk images as in usual replication snapshot backups.

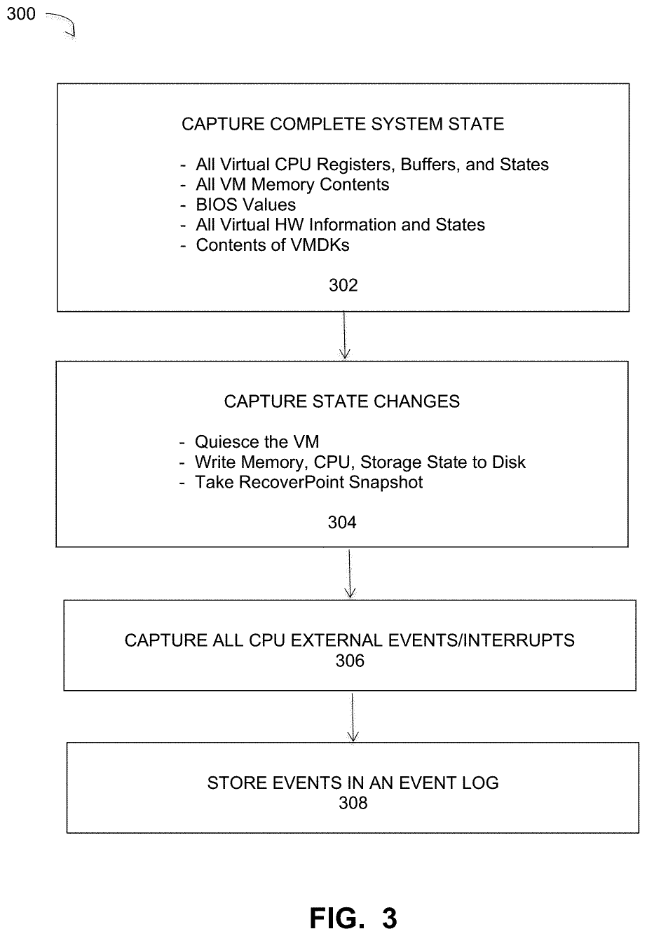

FIG. 4 illustrates an example event and state time line as captured by the bug reproduction process under some embodiments. As shown in FIG. 4, a linear time line 402 comprises a number of states 404 denoted Sn for the VM. A capture process of the bug reproduction process captures the full state of the VM at defined times or time intervals. For the example of FIG. 4, five such states S1 to S5 are captured as shown. In between the captured states are typically a number of events or interrupts, as shown by vertical lines 406. Any number of events or interrupts may be present depending on the activity of the VM, and the periodicity of the state capture. In an embodiment the states Sn can be captured on a regular periodic basis based on time or number of CPU cycles. Alternatively, they may be capture based on other synchronous or asynchronous events, such as a threshold number if events/interrupts, or any other user definition, for instance an automatic script can capture events in application level and create the checkpoints, and so on.

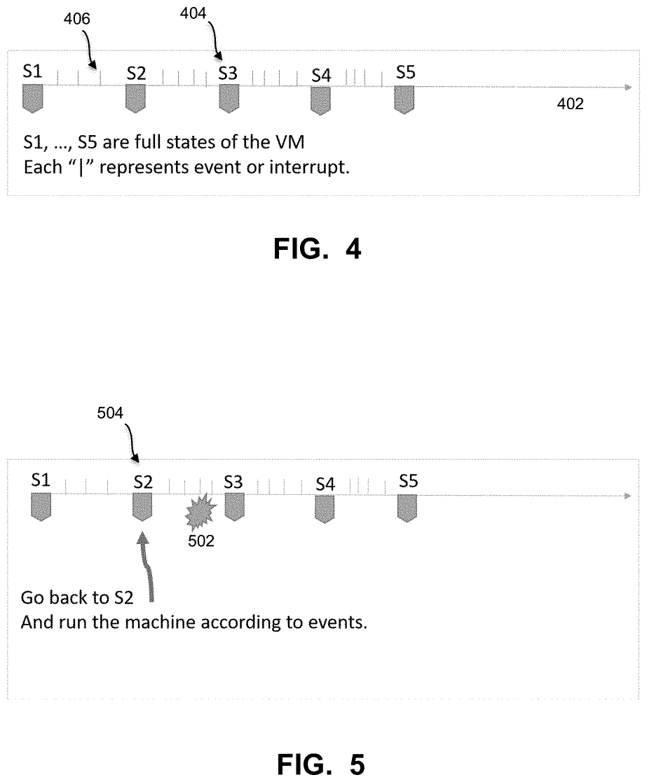

During operation of the VM some time along time line 402, it is presumed that a bug condition is detected. In general it is usually known approximately what time such a problem occurred. The bug reproduction process allows the user to replay the sequence surrounding the bug condition. FIG. 5 illustrates the time line of FIG. 4 with an example bug condition 502 occurring between states S2 and S3.

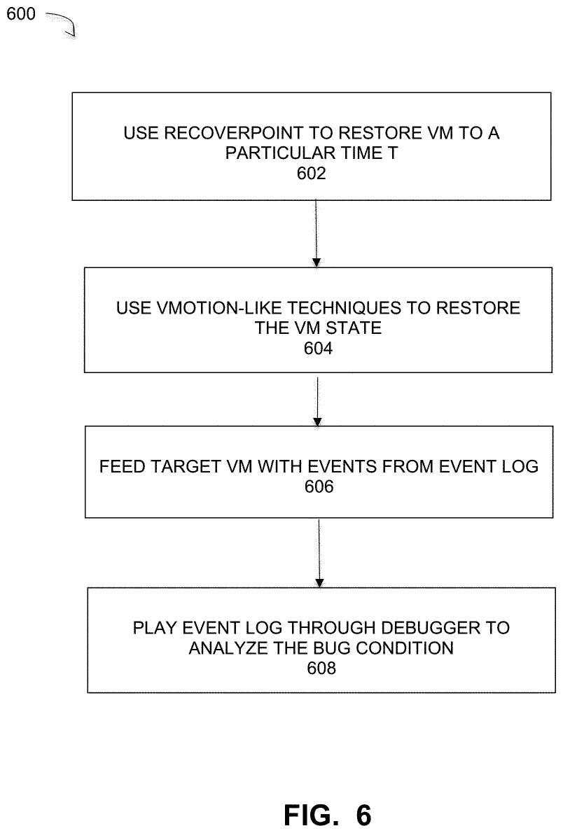

Since it is known more or less the time at which the problem occurred, the process can return the VM to the state before it occurred, such as to time T 504 by using certain RecoverPoint disaster recovery and loading the captured state created using the VMotion VM migration techniques. FIG. 6 is a flowchart that illustrates a method of replaying a bug condition under some embodiments. As shown in FIG. 6, process 600 starts with using RecoverPoint disaster recovery to restore the VM to a specific time T, step 602. Next, the process restores the VM state similar to techniques done in VMotion to reproduce the memory and associated CPU as it was at the time T, step 604.

In step 606, the process feeds the VM with the events from the event log. This is done by having the VM re-execute the events from the event log. This process essentially guarantees the ability to reproduce the same problem 502 that was experienced starting at time T 504. A user can then play the event log through a debugger or other tools that will shed light on the issue, step 608. The problematic issue is guaranteed to be reproduced, as the lockstep event log (data and timing) information is built in a way that ensures exact replay across multiple CPU scenarios. Therefore replaying the log on the same VM will exhibit the same behavior, thus reproducing the bug condition. With reference to FIG. 5, the process identifies a problem 502 somewhere between the times of S2 and S3. The process goes back in time using RecoverPoint and captured machine state mechanisms, and then proceeds to run the captured external events from the event log of S2 to S3. Though the example illustration shows the process going back to the immediately previous full state, embodiments are not so limited. The process can go back to any previous full state or any time previous or prior to the bug. If the exact timing of the bug is difficult to pinpoint, it is possible to go back earlier in time to be on the safe side, and then perform the replay and analysis. After a section is “cleared” of wrong doing the next time the bug needs reproduction, the user can go back to a more adjacent time and the next reproduction can be more efficient as more information about the overall situation has been gained.

The bug reproduction process provides an effective way of reconstructing bug scenarios in VMs. Embodiments use application consistent snapshots and the capture of a full VM state to create a completely consistent point in time state of the target VM, and then replays captured CPU lockstep events to consistently and repeatedly replay a particular scenario, such as a fault or bug condition. This allows 100% reproduction of bug scenarios especially those that are extremely difficult to reproduce

### System Implementation

Embodiments of the processes and techniques described above can be implemented on any appropriate software development system or network server system. Such embodiments may include other or alternative data structures or definitions as needed or appropriate.

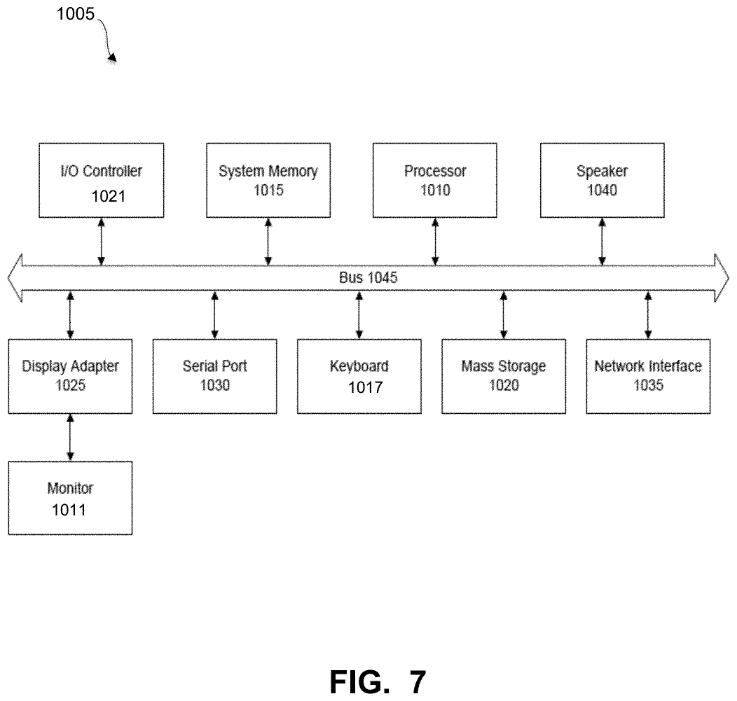

The network of FIGS. 1 and/or 2 may comprise any number of individual client-server networks coupled over the Internet or similar large-scale network or portion thereof. Each node in the network(s) comprises a computing device capable of executing software code to perform the processing steps described herein. FIG. 7 shows a system block diagram of a computer system used to execute one or more software components of the present methods and systems described herein. The computer system 1005 includes a monitor 1011, keyboard 1017, and mass storage devices 1020. Computer system 1005 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1005. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1005 is intended to illustrate one example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, among other examples), near field communication (NFC), radio-frequency identification (RFID), mobile or cellular wireless. For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of reproducing a bug condition in a software program executed on a virtual machine by a central processing unit (CPU), comprising:
capturing an initial state and changes in the initial state of the virtual machine in a sequence of subsequent states;
capturing all external CPU events between each of the states of the initial state and the subsequent states;
storing the events in an event log;
upon identification of an approximate time of the bug condition, restoring the virtual machine to a particular time proximately before the time of the bug condition; and
re-executing, in the virtual machine, the events in the event log to reproduce the bug condition.

2. The method of claim 1 wherein the initial state comprises: a content of substantially all virtual CPU registers and buffers, contents of the virtual machine memory, CPU BIOS (basic input/output system) values, virtualized hardware state, and contents of the virtual machine disk storage.

3. The method of claim 2 wherein the step of capturing the initial state comprises:
quiescing the virtual machine to pause all input/output activity to the virtual machine and ensure a consistent state of the virtual machine;
writing the state of the virtual machine memory and CPU to a storage location different from the virtual machine memory or disk; and
taking a replication snapshot backup of the virtual machine.

4. The method of claim 3 wherein the replication snapshot backup comprises a DellEMC® RecoverPoint™ snapshot.

5. The method of claim 3 wherein the CPU events comprise interrupt signals to the CPU emitted by one of a hardware component or software process indicating a system event that requires immediate attention by the CPU.

6. The method of claim 5 wherein the subsequent states are captured on a regular periodic basis after the initial state.

7. The method of claim 5 wherein the events comprise all network traffic data impacting the virtual machine, CPU interrupts, and wherein the event log stores the events and timing information of each event of the events.

8. The method of claim 3 wherein the capturing step is performed by constructs of VMware® VMotion™ process that captures a full state of the virtual machine on a source hypervisor and transfers the full state information to a target hypervisor and re-executes the virtual machine on the target hypervisor.

9. The method of claim 3 wherein the virtual machine is executed in a fault tolerant mode in lockstep with a slave virtual machine, and wherein a failure of the virtual machine will cause take over by the slave virtual machine through a synchronization process executed by the source hypervisor.

10. The method of claim 1 further comprising transmitting information regarding reproduction of the bug condition to a debugger process of a software development server for analysis of the bug condition.

11. A computer-implemented method of providing a record and replay method of bug reproduction for a virtual machine, comprising:
creating static snapshot backups of the virtual machine at various points in time using a replication process that ensures data of the virtual machine is correct at any point-in-time;
capturing events for a central processing unit (CPU) executing a hypervisor program managing the virtual machine using a CPU lockstep program to synchronize CPU cycles and the events with the data of the virtual machine at any point-in-time; and
storing the events and timing information for each event of the events in a log, wherein the events comprise all network traffic data impacting the virtual machine and CPU interrupts.

12. The method of claim 11 wherein the static snapshot backups capture a full state of the virtual machine through a virtual machine live migration method using a source hypervisor managing the virtual machine and a target hypervisor managing the virtual machine after migration.

13. The method of claim 12 wherein the full state comprises: a content of all or substantially all virtual CPU registers and buffers, contents of the virtual machine memory, CPU BIOS (basic input/output system) values, virtualized hardware state, and contents of the virtual machine disk storage.

14. The method of claim 13 further comprising allowing repeated replay of the events proximate a bug condition, such that the repeated replay consistently reproduces the bug condition for analysis by debugging tools for analysis and rectification of the bug condition.

15. The method of claim 11 wherein the step of creating the static snapshots comprises capturing an initial state and subsequent states of the virtual machine

16. The method of claim 15 wherein the step of capturing an initial or subsequent state of the virtual machine comprises:
quiescing the virtual machine to pause all input/output activity to the virtual machine and ensure a consistent state of the virtual machine;
writing the state of the virtual machine memory and CPU to a storage location different from the virtual machine memory or disk; and
taking a replication snapshot backup of the virtual machine.

17. The method of claim 5 wherein the subsequent states are captured on a regular periodic basis after the initial state, and wherein the events comprise asynchronous interrupts to the CPU in between each pair of captured states.

18. An apparatus for reproducing a bug condition in a software program executed on a virtual machine by a central processing unit (CPU), comprising:
a replication component creating static snapshot backups of the virtual machine at various points in time using a process that ensures data of the virtual machine is correct at any point-in-time;
a CPU lockstep component capturing events for a central processing unit (CPU) executing a hypervisor program managing the virtual machine to synchronize CPU cycles and the events with the data of the virtual machine at any point-in-time; and
an event logger component storing the events and timing information for each event of the events in a log, wherein the events comprise all network traffic data impacting the virtual machine and CPU interrupts.

19. The apparatus of claim 18 wherein the static snapshot backups capture a full state of the virtual machine through a virtual machine live migration component using a source hypervisor managing the virtual machine and a target hypervisor managing the virtual machine after migration, and wherein the full state comprises: a content of substantially all virtual CPU registers and buffers, contents of the virtual machine memory, CPU BIOS (basic input/output system) values, virtualized hardware state, and contents of the virtual machine disk storage.

20. The apparatus of claim 19 further comprising a test component allowing repeated replay of the events proximate a bug condition, such that the repeated replay consistently reproduces the bug condition for analysis by debugging tools for analysis and rectification of the bug condition.
